(19) United States
(12) Patent Application Publication
(10) Pub. No.: US 2009/0088328 A1
(43) Pub. Date: Apr. 2, 2009

(54) Microarray Quality Control

(75) Inventors: Mansoor S. Mohammed, Oakville (CA); Natasa Dzidic, Laguna Beach, CA (US)

Correspondence Address: FOLEY & LARDNER LLP, P.O. BOX 80278, SAN DIEGO, CA, 92138-0278, US

(73) Assignee: QUEST DIAGNOSTICS INVESTMENTS INCORPORATED

(21) Appl. No.: 11/791,137

(22) PCT Filed: Nov. 22, 2005
(86) PCT No.: PCT/US05/42377

§ 371 Date: Oct. 8, 2008

Related U.S. Application Data
(60) Provisional application No. 60/631,088, filed on Nov. 23, 2004.

(51) Int. Cl. C40B 30/00

(52) U.S. Cl. 506/7

(57) ABSTRACT

The present invention relates to methods of quality control of manufactured nucleic acid arrays. Fluorescence detection is used to evaluate the quality of a printed nucleic acid array without the need to add or otherwise link a fluorescent compound or dye to the nucleic acid. Nucleic acid arrays suitable for this method are those where the spots of the array are formed by printing a solution that contains the nucleic acid in an ion containing solution. Printing quality may be evaluated by measuring the intensity of fluorescence at the location of each printed sample, and/or by measuring the “morphology” (i.e. shape) of the printed sample. Printed spots can be “imaged” by measuring fluorescence across a spotted sample in two dimensions. The resulting image of a printed spot can be compared with a reference printed image expected for the printing equipment and solid phase used.

### FIELD OF THE INVENTION

The present invention relates to the manufacture and use of nucleic acid arrays. In a particular aspect, the invention relates to monitoring the quality of nucleic acid arrays.

### BACKGROUND OF THE INVENTION

Nucleic acid arrays, also known as microarrays or biochips, are important tools in the biotechnology industry and related industries. Several useful applications for microarray procedures have been developed, including nucleic acid sequencing, gene expression and genetic mutation analysis. One important application is in the analysis of differential gene expression in which the expression of genes in different samples, often a sample of interest and a control sample, are compared and specific genes that are differentially expressed are identified. In another example, nucleic acid arrays are used for array-based comparative genomic hybridization (array-CGH), which provides advantages over conventional chromosome spread-based CGH techniques in that it provides improved quantitative accuracy, higher resolution and facilitates the analysis of samples. Although arrays made of oligonucleotides (Lucito et al., Genome Research. 10:1726-1729, 2000) and cDNA clones (Pollack et al., Nat. Genet. 23;41-46, 1999) have been successfully employed for array-CGH, arrays made from large insert genomic clones such as BACs or PACs (Solinas-Toldo et al., Genes Chromosomes Canc. 20:399-407, 1997; Pinkel et al., Nat. Gen. 20:207-211, 1998) provide the best performance for the analysis of total genomic DNA (Albertson et al., Human Mol. Genet. 12: R145-R152, 2003).

The process of manufacturing nucleic acid arrays involves depositing a plurality of nucleic acids (nucleic acid segments) in the form of “spots” to discrete locations of a solid surface, a process known as “printing” a nucleic acid array. A variety of microarray equipment (e.g., BioRobotics Microgrid and others; collectively “arrayers”) is available for printing arrays. The nucleic acids can comprise oligonucleotides, reverse transcribed cDNA clones or large insert genomic clones, such as BACs. Following printing, the nucleic acid arrays can be hybridized with one or more samples of nucleic acid for a desired purpose, e.g., genomic analysis. Robotic automation of this process allows for high throughput analysis of numerous test samples.

The quality of the nucleic acid array based testing is effected by the consistency and uniformity in the printing process. In practice, variations in the amount of sample loaded into each spot and the shape of the spot formed upon sample loading can impact assay accuracy and reliability. Causes of such variations include inconsistencies in fluid control, irregularities of the solid surface, inconsistencies in the ability of the nucleic acids to become immobilized to the solid surface, irregularities resulting from post sample procedures, such as heating and blocking, and the like. Specific spots of printed nucleic acid or specific portions of a printed array that are of poor quality should be identified so that results are not misleading. In some cases, an entire array should be discarded.

Variations in nucleic acid printing quality may be impacted by the type of nucleic acid material being printed. For example, the high molecular weight DNA large insert genomic clones (e.g., BACs or PACs), can be viscous and therefore cause particular printing difficulties. The ability to test print quality allows optimization of printing parameters for different types of nucleic.

Printing quality has been evaluated by inspecting the array surface for irregularities prior to printing or by evaluating printed spots prepared with dye-only solutions or dye-oligo DNA solutions in representative test print runs. The quality of printed nucleic acids also has been evaluated by hybridizing to appropriate nucleic acids. Automated array quality control systems have been described, see, e.g., U.S. Pat. No. 6,558,623. However, new methods of determining array printing quality are desired that offer precise information about the quality of each printed spot, that do not use extra reagents or samples, and that evaluate the printing quality of nucleic acid arrays immediately post printing or even just prior to hybridization.

### SUMMARY OF THE INVENTION

It is an object of the present invention to provide a method of determining the printing quality of nucleic acid arrays and to provide methods to determine the efficiency of procedures to block non-specific binding on nucleic acid arrays.

In one aspect, the present invention utilizes fluorescence detection to evaluate the quality of a printed nucleic acid array without the need to add or otherwise link a fluorescent compound or dye to the nucleic acid. Nucleic acid arrays suitable for this analysis are those where the spots of the array are formed by printing a solution that contains the nucleic acid and one or more ions. Thus, the array is formed from nucleic acid in an ionic solution and the printing quality is evaluated by the fluorescence associated with each printed spot.

Printing quality may be evaluated by measuring the intensity of fluorescence at the location of each printed sample, and/or by measuring the “morphology” (i.e. shape) of the printed sample. Printed spots can be “imaged” by measuring fluorescence across a spotted sample in two dimensions. The resulting image of a printed spot can be compared with a reference printed image expected for the printing equipment and solid phase used.

The methods can be used to determine the quality the quality of specific spots on an array, to determine the quality of specific regions of an array, or to determine the quality of an array as a whole. Spot quality and/or array quality can be detected immediately following array printing or after the array is subject to processing steps prior to hybridization. Such steps may include exposing the array to heat, humidity, UV irradiation, a blocking procedure, and/or washing.

In the case where the quality of a blocking step for non-specific binding is performed, the quality of blocking can be determined by measuring fluorescence at each loaded sample prior to and following a blocking procedure. A decrease in the fluorescence after the washing and/or blocking procedure indicates the efficiency of the blocking and/or washing step.

The term “array” as used herein, refers to a plurality of “target elements”, or “printed samples” or “spots”, each comprising a defined amount of one or more biological molecules, e.g., polypeptides, nucleic acid molecules, or probes, deposited at discrete locations on a substrate surface. As used herein, the term “nucleic acid array” refers an array wherein the target elements comprise nucleic acid samples. In preferred embodiments, the plurality of spots comprises nucleic acid samples, deposited at preferably at least about 50, at least about 100, at least about 300, or at least about 500 discrete locations on the surface. The plurality may comprise multiple repeats of the same nucleic acid segments to produce, e.g., duplicate spots, triplicate spots, quadruplicate spots, quintuplicate spots, etc.

The term “printing” as used herein, refers to the process of depositing nucleic acid samples onto discrete locations of a solid surface.

The term “printing buffer” or “printing solution” as used herein, refers to a solution which is deposited to the array surface. Nucleic acid which is to be printed on an array is contacted with an appropriate printing solution prior to printing the array.

The term “ion” as used herein, refers to an atom or group of atoms carrying an electric charge by virtue of having gained or lost one or more valence electrons. The term “ionic solution” as used herein, refers to any solution that comprises ions. For example, any solution containing a salt and/or a buffer is considered an ionic solution. As used herein, an ionic solution contains ions at a concentration that exceeds that which is present in dionized water, or a concentration greater than 2×10⁻⁷ M, more preferably at least 4×10⁻⁷ M, more preferably at least 1×10⁻⁶ M, more preferably at least 5×10⁻⁶ M, more preferably at least 1×10⁻⁵ M, more preferably at least 5×10⁻⁵ M, more preferably at least 1×10⁻⁴ M, more preferably at least 5×10⁻⁴ M, more preferably at least 1×10⁻³ M, more preferably at least 5×10⁻³ M, more preferably at least 1×10⁻² M, more preferably at least 5×10⁻² M, and more preferably at least 1×10⁻¹ M.

The term salt as used herein refers to one or more compounds that result from replacement of part or all of the acidic hydrogen of an acid by a metal, or an element acting like a metal.

As used herein, the term “arrayer” refers to equipment capable of printing an array by dispensing fluids at discrete locations on a solid surface. A variety of automated arrayers are available, for example the BioRobotics Microgrid, the Affymetrix Arrayer, the GeneMachines Omnigrid and the Packard Instrument Company Biochip Arrayer.

The term “spot” or “printed sample” as used herein, refers to the material that has been deposited at discrete locations of a solid surface by printing. For example, a printed sample or spot of a nucleic acid array refers to the individual locations where a nucleic acid containing solution has been deposited.

As used herein, the term “nucleic acid” refers to segments or portions of cDNA, genomic DNA, or RNA. A nucleic acid segment may be about 20 to about 200 nucleotides; about 200 to about 1,000 nucleotides; about 1,000 to about 100,000 nucleotides; or about 100,000 to about 1,000,000 nucleotides in length. Nucleic acid may be contained within a nucleic acid vector (e.g., plasmids, cosmids, etc.), or an artificial chromosome, such as a bacterial artificial chromosome (BAC) or P-1 derived artificial chromosome as is known in the art. In some aspects, the nucleic acid may comprise one or more peptide nucleic acids, i.e., nucleic acids that have a 2-aminoethyl-glycine linkage replacing the normal phosphodiester backbone of DNA (Nielsen et al., Science, 254:1497-1500, 1991; Hyrup and Nielsen, Bioorg. Med. Chem., 4:5-23, 1996).

The term “hybridization” as used herein, refers to the pairing of substantially complementary nucleotide sequences (strands of nucleic acid) to form a duplex or heteroduplex through formation of hydrogen bonds between complementary base pairs in accordance with Watson-Crick base pairing. Hybridization is a specific, i.e., non-random, interaction between two complementary polynucleotides. Hybridization and the strength of hybridization (i.e., the strength of the association between the nucleic acids) is influenced by such factors as the degree of complementary between the nucleic acids, stringency of the conditions involved, and the Tₘ of the formed hybrid.

The term “fluorescence” as used herein, refers to visible light that may be emitted from a substance upon absorption of light energy. Generally, the fluorescence emitted is of a longer wavelength than the wavelength of the absorbed light energy.

The term “about” as used herein, means “approximately” or “nearly”. In the context of numerical values, the term may be construed to estimate a value that is ±10% of the value or range recited.

### DETAILED DESCRIPTION OF THE INVENTION

Nucleic acid arrays are common tools used in the biotechnology industry and related industries. Most nucleic acid array protocols require multiple steps such as printing, immobilization of target elements to the array surface, blocking of non-specific binding to the array, and hybridization to nucleic acids. Results from array analysis can be adversely effected by the printing quality and with the quality of processing steps required prior to hybridization. In one aspect, the present invention provides methods for determining the printing quality of nucleic acid arrays. In another aspect, methods are provided for determining the efficacy of post printing/pre-hybridization procedures such as the blocking of non-specific binding to nucleic acid arrays.

In accordance with the methods, printing quality or efficacy of post printing/pre-hybridization procedures is evaluated by detecting fluorescence associated with the printed nucleic acid containing printing solution. Nucleic acid samples to be printed are dissolved or diluted in an ion containing printing solution prior to array printing. Although not wishing to be bound by any theory, it is believed that the ions and/or nucleic acid in a printing solution have autofluorescent properties which can be detected with an appropriate device (e.g. photomultiplier tube or charge coupled device).

A suitable ionic printing solution may be aqueous or non-aqueous or a mixture of a aqueous liquid with a water miscible non-aqueous liquid. Ionic solutions are prepared by dissolving one or more ionic compounds into a liquid solution. Preferred ionic compounds include a salt or a buffer. In certain embodiments, the ionic solution comprises a suitable ionic compound at a concentration of at least 1 mM, at least 10 mM, at least 50 mM or at least 100 mM. In some embodiments, the ionic compound(s) in the printing solution is between 1-10 mM; 10-100 mM; 100-200 mM; or 200 mM-2 M.

The ionic solution preferably contains at least one ionic species of low molecular weight. The ionic species is preferably less than about 1,000 daltons, or less than about 500 daltons.

The DNA containing printing solution is preferably capable of generating fluorescence with a wavelength of between about 350 nM and about 600 nM. Suitable ionic compounds includes salts or buffers, for example, as tris(hydroxymethyl)aminomethane (Tris), Tris-HCL, N-2-hydroxyethylpiperazine-N′-2-ethanesulfonic acid (HEPES), 3-(N-morpholino)propanesulfonic acid (MOPS), piperazine-N-N′-bis(2-ethanesulfonic acid) (PIPES), 2-(N-morpholino)ethanesulfonic acid (MES), ethylenediaminetetraacetic acid (EDTA) or salts of any of the above, sodium citrate (or sodium citrate buffer; SSC), sodium phosphate, sodium hydroxide, potassium chloride, magnesium chloride, potassium phosphate and sodium chloride.

In one embodiment, the printing solution contains a Tris buffer or a salt thereof, the concentration being about 50 mM to about 300 mM, preferably about 75 mM to about 250 mM, more preferably about 100 to about 200 mM. In another embodiment, the printing solution contains EDTA or a salt thereof, the concentration being about 5 to about 30 mM, more preferably about 10 to about 20 mM. In a related embodiment, the an ionic printing solution further comprises about 50 to about 100 mM NaOH. In another embodiment, the ionic printing solution comprises Tris, EDTA and sodium hydroxide. In a preferred embodiment, the ionic printing solution comprises 150 mM Tris, 15 mM EDTA, and 75 mM NaOH. In another embodiment, the printing solution comprises a salt of phosphate buffer, the concentration being about 50 mM to 300 mM or 100 mM to 200 mM and at a pH in the range of 6.0 to 7.0, 7.0 to 8.0, or 8.0 to 9.0. In yet another embodiment, the printing solution comprises 150 mM sodium phosphate buffer, pH 8.5.

Characteristics of the fluorescence of each printed sample, or spot, on an array can be observed to determine the printing quality of the array. For example, typically arrays of “high” quality will have spots of uniform fluorescent intensity and morphology; the spots of high quality arrays will be properly aligned on the solid surface.

Fluorescence intensity from each spot and spot morphology as well as spot alignment can be determined by visual or microscopic examination. Fluorescent array readers well known in the art can be used to measure fluorescence associated with the printed array. Such readers also may include a scanner and associated software to obtain an image of the spot and to compare the imaged spot with an ideal spot expected from the printing process. Fluorescence is detected by exciting the printed sample with a source of ultraviolet light. A laser or a xenon lamp or other ultraviolet source is suitable for this purpose. Detection of fluorescence from printed spots is preferably performed by scanning at about 350 nM to about 600 nM, more preferably at about 450 to about 600 nM. In one preferred embodiment, detection of fluorescence is preformed at 532 mM (Cy3 detection frequency) with laser excitation. In another preferred embodiment, detection of fluorescence is preformed at 635 nM (Cy5 detection frequency) with laser excitation.

Devices and methods for the detection of fluorescence are well known in the art, see, e.g., U.S. Pat. Nos. 5,539,517; 6,049,380; 6,054,279; 6,055,325; and 6,294,331. Any known device or method, or variation thereof, can be used or adapted to practice the methods of the invention, including array reading or “scanning” devices, such as scanning and analyzing multicolor fluorescence images; see, e.g., U.S. Pat. Nos. 6,294,331; 6,261,776; 6,252,664; 6,191,425; 6,143,495; 6,140,044; 6,066,459; 5,943,129; 5,922,617; 5,880,473; 5,846,708; 5,790,727; and, the patents cited in the discussion of arrays, herein. See also published U.S. Patent Application Nos. 20010018514; 20010007747; and published international patent applications Nos. WO0146467 A; WO9960163 A; WO0009650 A; WO0026412 A; WO0042222 A; WO0047600 A; and WO0101144 A. An automated arrayer device including spot analyzer comprising light sources, cameras, and computer to receive and analyze slide image data from a camera reader is described in U.S. Pat. No. 6,558,623.

For example, a spectrograph can image an emission spectrum onto a two-dimensional array of light detectors; a full spectrally resolved image of the array is thus obtained. Photophysics of the fluorescence, e.g., fluorescence quantum yield and photodestruction yield, and the sensitivity of the detector are read time parameters for an oligonucleotide array. With sufficient laser power and use of Cy5™ or Cy3™, which have lower photodestruction yields, an array can be read in less than 5 seconds.

Charge-coupled devices or CCDs can be used for array scanning as described herein in microarray scanning systems. Color discrimination can also be based on 3-color CCD video images; these can be performed by measuring hue values. Hue values are introduced to specify colors numerically. Calculation is based on intensities of red, green and blue light (RGB) as recorded by the separate channels of the camera. The formulation used for transforming the RGB values into hue, however, simplifies the data and does not make reference to the true physical properties of light. Alternatively, spectral imaging can be used; it analyzes light as the intensity per wavelength, which is the only quantity by which to describe the color of light correctly. In addition, spectral imaging can provide spatial data, because it contains spectral information for every pixel in the image. Alternatively, a spectral image can be made using brightfield microscopy, see, e.g., U.S. Pat. No. 6,294,331.

Specific spots of undesirable morphology or unsuitable intensity or similar undesirable regions of an array can be designated as “poor” quality and excluded from the post testing analysis. In this regard, fluorescence intensity can be determined as a function of array position, and “outliers” (data deviating from a predetermined statistical distribution)” can be removed from downstream data analysis. The resulting data can be displayed as an image with color in each region varying according to the light emission or binding affinity between targets and probes. See, e.g., U.S. Pat. Nos. 5,324,633; 5,863,504; and 6,045,996. Alternatively, an entire array determined to be of poor quality can be discarded before use.

In practicing the methods described herein, any known array and/or method of making and using arrays can be incorporated in whole or in part, or variations thereof, as disclosed, for example, in U.S. Pat. Nos. 6,562,565; 6,277,628; 6,277,489; 6,261,776; 6,258,606; 6,054,270; 6,048,695; 6,045,996; 6,022,963; 6,013,440; 5,965,452; 5,959,098; 5,856,174; 5,830,645; 5,770,456; 5,632,957; 5,556,752; 5,143,854; 5,807,522; 5,800,992; 5,744,305; 5,700,637; 5,556,752; 5,434,049; see also, e.g., WO 99/51773; WO 99/09217; WO 97/46313; WO 96/17958; see also, e.g., Johnston, Curr. Biol. 8:R171-R174, 1998; Schummer, Biotechniques 23:1087-1092, 1997; Kern, Biotechniques 23:120-124, 1997; Solinas-Toldo, Genes, Chromosomes & Cancer 20:399-407, 1997; Bowtell, Nature Genetics Supp. 21:25-32, 1999. See also published U.S. Patent Applications Nos. 20010018642; 20010019827; 20010016322; 20010014449; 20010014448; 20010012537; 20010008765.

In some embodiments, the methods described herein may be used to determine the printing quality of arrays made by printing nucleic acid from large insert genomic clones, preferably contained within an artificial chromosome, such as a BAC or a P-1 derived artificial chromosome. Such arrays are particularly useful for array-based comparative genomic hybridization (array-CGH). In array-CGH, the array typically comprises a plurality of printed nucleic acid samples that together represents all or portions of a chromosomal region of interest, all or portions of a chromosome of interest, or all or portions of an entire genome of interest. Each member of such an array can comprise unique segments of a chromosome or overlapping segments of a chromosome.

Preferably, each printed nucleic acid sample on an array to be used for array-CGH comprises a nucleic acid segment that is between about 1,000 (1 kB) and about 1,000,000 (1 MB) nucleotides in length, more preferably between about 100,000 (100) and 300,000 (kB) nucleotides in length. The plurality of printed nucleic acid samples that together represents a chromosomal region of interest, a chromosome of interest, or an entire genome of interest generally reflects only portions of the total genome. For example, an array of nucleic acid samples together representing a complete chromosome may include segments of 150 kb in length, each segment being the sole sample from every 3-4 MB of chromosomal sequence. In this case, the array can be stated to represent locations that are spaced at intervals about 3-4 megabases (MB) along the chromosome. In such case, arrays with higher resolution can be prepared where each sample of nucleic acid is taken from the target chromosome at intervals of about 2-3 megabases, or more preferably at intervals of about 1-2 megabases. As already mentioned, arrays may represent all chromosomes of a genome. The number of different clones used reflects the extent of resolution.

A wide variety of organic and inorganic polymers, as well as other materials, both natural and synthetic, may be employed as the material for the solid surface. Illustrative solid surfaces include nitrocellulose, nylon, glass, diazotized membranes (paper or nylon), silicones, polyformaldehyde, cellulose, and cellulose acetate. In addition, plastics such as polyethylene, polypropylene, polystyrene, and the like can be used. Other materials which may be employed include paper, ceramics, metals, metalloids, semiconductive materials, cermets or the like. In addition substances that form gels can be used. Such materials include proteins (e.g., gelatins), lipopolysaccharides, silicates, agarose and polyacrylamides. Where the solid surface is porous, various pore sizes may be employed depending upon the nature of the system.

In preparing the surface, a plurality of different materials may be employed, particularly as laminates, to obtain various properties. For example, proteins (e.g., bovine serum albumin) or mixtures of macromolecules (e.g., Denhardt's solution) can be employed to avoid non-specific binding, simplify covalent conjugation, enhance signal detection or the like.

If covalent bonding between a compound and the surface is desired, the surface will usually be polyfunctional or be capable of being polyfunctionalized. Functional groups which may be present on the surface and used for linking can include carboxylic acids, aldehydes, amino groups, cyano groups, ethylenic groups, hydroxyl groups, mercapto groups and the like. The manner of linking a wide variety of compounds to various surfaces is well known and is amply illustrated in the literature. For example, methods for immobilizing nucleic acids by introduction of various functional groups to the molecules is known (see, e.g., Bischoff et al., Anal. Biochem. 164:336-344, 1987; Kremsky et al., Nucl. Acids Res. 15:2891-2910, 1987). Modified nucleotides can be placed on the target using PCR primers containing the modified nucleotide, or by enzymatic end labeling with modified nucleotides.

Alternative surfaces include derivatized surfaces such as chemically coated glass slides. One example, is CodeLink™ Activated Slide, Amersham Biosciences (manufactured by SurModics, Inc. as 3D-Link™) (see, e.g., the world wide web at the URL “amershambiosciences.com/aptrix/upp01077.nsf/Content/codelink_activated_slides”). These slides are coated with a 3-D surface chemistry comprised of a long-chain, hydrophilic polymer containing amine-reactive groups, to react with and covalently immobilize amine-modified DNA for microarrays. This polymer is covalently crosslinked to itself and to the surface of the slide and is designed to orient the immobilized DNA away from the surface of the slide to improve hybridization.

Use of membrane supports (e.g., nitrocellulose, nylon, polypropylene) for the nucleic acid arrays of the invention is advantageous because of well developed technology employing manual and robotic methods of arraying targets at relatively high element densities (e.g., up to 30-40/cm²). In addition, such membranes are generally available and protocols and equipment for hybridization to membranes are well known. Many membrane materials, however, have considerable fluorescence emission, where fluorescent labels are used to detect hybridization.

Arrays on substrates with much lower fluorescence than membranes, such as glass, quartz, or small beads, can achieve much better sensitivity. For example, elements of various sizes, ranging from about 1 mm diameter down to about 1 μm can be used with these materials. Small array members containing small amounts of concentrated target DNA are conveniently used for high complexity comparative hybridizations since the total amount of probe available for binding to each element will be limited. Thus, it is advantageous to have small array members that contain a small amount of concentrated target DNA so that the signal that is obtained is highly localized and bright. Such small array members are typically used in arrays with densities greater than 10⁴/cm². Relatively simple approaches capable of quantitative fluorescent imaging of 1 cm² areas have been described that permit acquisition of data from a large number of members in a single image (see, e.g., Wittrup et al., Cytometry 16:206-213, 1994).

Typically, the printed nucleic acid segments are immobilized to the solid surface prior to hybridization. Many methods for immobilizing nucleic acids on a variety of solid surfaces are known in the art. For instance, the solid surface may be a membrane, glass, plastic, or a bead. The desired component may be covalently bound or noncovalently attached through nonspecific binding. The immobilization of nucleic acids on solid surfaces is discussed more fully below.

Covalent attachment of the nucleic acids to glass or synthetic fused silica can be accomplished according to a number of known techniques. Such substrates provide a very low fluorescence substrate, and a highly efficient hybridization environment. There are many possible approaches to coupling nucleic acids to glass that employ commercially available reagents. For instance, materials for preparation of silanized glass with a number of functional groups are commercially available or can be prepared using standard techniques. Alternatively, quartz cover slips, which have at least 10-fold lower auto fluorescence than glass, can be silanized.

To optimize a given assay format, one of skill can determine sensitivity of fluorescence detection for different combinations of membrane type, fluorophore, excitation and emission bands, spot size and the like. In addition, low fluorescence background membranes have been described (see, e.g., Chu et al., Electrophoresis 13:105-114, 1992).

The ability to detect printing quality of a nucleic acid array as described herein can be used to optimize printing conditions for a particular set of circumstances. For example, evaluation of print quality in initially prepared arrays may reveal problems with the arrayer equipment such as misalignment of spots, or reveal problems with the printing parameters for a particular nucleic acid source. In the first instance, the arrayer equipment can be adjusted accordingly; in the second instance, the printing procedure can be modified.

Spot quality is dependent on the nature of the material to be printed. For example, solutions comprising high molecular weight DNA, such as large insert genomic clones (e.g., BACs or PACs), can be viscous and therefore cause particular printing difficulties (Albertson et al., Human Mol. Genet. 12: R145-R152, 2003). Various factors are known to effect spot size and include: Size of the end of the tip (larger tips make larger spots and visa versa); Dwell time of the pin on the surface (the longer a Pin touches the surface, the more sample will be delivered); Viscosity of the sample (more viscous samples will make smaller spots); and Hydrophobicity of the substrate (the more hydrophobic the surface, the smaller the spot).

The ability to detect printing quality of a nucleic acid array as described herein also finds use in evaluating the efficacy of post printing procedures used prior to hybridization. The present methods in the regard are advantageous because they do not preclude use of an individual array for further the evaluation. Examples of typical post printing/pre-hybridization procedures include: immobilization of printed nucleic acids to the solid surface, denaturation of the printed nucleic acids, blocking of the array to reduce non-specific binding during hybridization and washing.

The efficacy of the step of immobilizing nucleic acid to an array can be determined by evaluating fluorescence associated with the spot before and/or after washing. A reduced level of fluorescence (intensity or morphology) of the spots after washing indicates that immobilization has been achieved. Conversely, the lack of a reduction in the fluorescence at each spot, may be indicative of poor efficiency of immobilization.

The efficacy of a blocking step can be determined by evaluating fluorescence associated with the spot before and after blocking. A reduced level of fluorescence (intensity or morphology) of the spots after blocking indicates that the blocking has been achieved. Conversely, the lack of a reduction in the fluorescence at each spot, may be indicative of poor efficiency of the blocking procedure.

The efficacy of a washing step to remove salt from the nucleic acid that has been immobilized on the support can be determined by evaluating fluorescence associated with the spot before and after washing. A reduced level of fluorescence (intensity or morphology) of the spots after washing indicates that the salt has been removed. Conversely, the lack of a reduction in the fluorescence at each spot, may be indicative of poor efficiency of the washing or blocking procedure.

The invention will now be described in greater detail by reference to the following non-limiting examples.

### EXAMPLE 1

### Determination of Printing Quality of Nucleic Acid Arrays Printed on Glass Slides

A sample collection of the large insert DNA clones (BACs, PACs, cosmids) intended for printing was suspended at a concentration of 75-100 ng/μl in printing buffer comprising 150 mM sodium phosphate, pH 8-9 and loaded into 384 well plates. The DNA was briefly fragmented using an ultrasonic water-bath processor set at 100 A with 70 W output for 5 seconds. Gel electrophoreses (0.8-1.0% agarose) was used to confirm that the size of the fragmented DNA ranged homogenously within 500 base pairs and larger.

Array printing was performed using a Molecular Dynamics GenIII Array Spotter with ASC-XT1.1 software. The DNA clones were printed on plain glass slides cleaned according to a standard base/acid protocols. The following printing parameters were used: spot diameter, 240-300 μm; spot buffer, 100 μm; humidity 55-60%.

Printing quality was evaluated by measuring fluorescence of the spots by scanning with a laser scanner (e.g., Axon 4000, 4100, 4200) set at the 532 nm laser excitation. Background fluorescence of plain glass slides was about 3000 (PMT units). The fluorescence intensity of the spotted DNA was about 10,000, and the size of each spot was approximately 290 μm diameter. Based on the intensity, size and morphology of the fluorescence of each spot as well the uniformity of the fluorescence all of the spots on the array; the array was designated as “high quality.” Subsequently, the array was successfully employed for further procedures and protocols of CGH.

### EXAMPLE 2

### Determination of Printing Quality of Nucleic Acid Arrays Printed on CodeLink™ Activated Slides

An array was prepared using the same DNA, arraying procedure and fluorescent analysis as described in Example 1 except that the DNA was printed on a CodeLink™ Activated Slide (Amersham Biosciences). Background fluorescence of the CodeLink™ Activated Slide was about 15,000. The fluorescence intensity of the spotted DNA was about 65,000 and the size of each spot was approximately 180 μm. Based on the intensity, size and morphology of the fluorescence of each spot as well the uniformity of the fluorescence all of the spots on the array; the array was designated as “high quality.” Subsequently, the array was successfully employed for further procedures and protocols of CGH.

All patents and publications mentioned in the specification are indicative of the levels of those of ordinary skill in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations which is not specifically disclosed herein. Thus, for example, in each instance herein any of the terms “comprising,” “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Other embodiments are set forth within the following claims.

That which is claimed is:

1. A method for determining the printing quality of a nucleic acid array prior to hybridization, said method comprising:
(a) printing an array of nucleic acid samples onto a solid support, each sample comprising nucleic acid in an ionic solution; and
(b) detecting fluorescence of printed samples to determine the quality of printing.

2. A method according to claim 1, wherein said nucleic acid comprises DNA.

3. A method according to claim 1, wherein said nucleic acid comprises cDNA.

4. A method according to claim 1, wherein said nucleic acid comprises oligonucleotides.

5. A method according to claim 1, wherein said nucleic acid comprises at least one peptide nucleic acid.

6. A method according to claim 1, wherein said nucleic acid comprises genomic DNA.

7. A method according to claim 1, wherein said nucleic acid comprises an artificial chromosome containing a DNA insert.

8. A method according to claim 7, wherein said artificial chromosome is a bacterial artificial chromosome (BAC).

9. A method according to claim 7, wherein said artificial chromosome is a P-1 derived artificial chromosome (PAC).

10. A method according to claim 1, wherein said nucleic acid is between about 20 and about 1,000,000 nucleotides in length.

11. A method according to claim 1, wherein said array of nucleic acid samples represents a plurality of segments of DNA, each segment printed to a discrete spot of said array, wherein said plurality of segments represent locations on a genome spanning at least one chromosome.

12. A method according to claim 11, wherein said segments of DNA represent locations on said at least one chromosome spaced at intervals of about 3-4 megabases along said at least one chromosome.

13. A method according to claim 11, wherein said segments of DNA represent locations on said at least one chromosome spaced at intervals of about 2-3 megabases along said at least one chromosome.

14. A method according to claim 11, wherein said segments of DNA represent locations on said at least one chromosome spaced at intervals of about 1-2 megabases along said at least one chromosome.

15. A method according to claim 1, wherein said solid surface is selected from the group consisting of glass, nitrocellulose, a porous membrane, cellulose acetate, polyvinylidine fluoride (PVDF) and nylon.

16. A method according to claim 1, wherein said solid surface comprises at least about 300 discrete locations.

17. A method according to claim 1, wherein said solid surface comprises at least about 500 discrete locations.

18. A method according to claim 1, wherein said detection of fluorescence is performed between about 350 nm to about 600 nm.

19. A method according to claim 1, wherein said detection of fluorescence is performed at 532 nm.

20. A method according to claim 1, wherein said ionic solution is a solution comprising a salt and/or a buffer.

21. A method according to claim 1, wherein said ionic solution comprises one or more of the group consisting of ethylenediaminetetraacetic acid (EDTA), sodium chloride, SSC buffer, Tris buffer, TE buffer and sodium phosphate.

22. A method according to claim 1, wherein said ionic solution comprises one or more of the group consisting of about 50 mM to about 300 mM Tris; about 5 to about 30 mM EDTA; and about 50 to about 100 mM NaOH.

23. A method according to claim 1, wherein said ionic solution comprises 150 mM Tris, 15 mM EDTA and 75 mM NaOH.

24. A method according to claim 1, wherein said ionic solution comprises sodium phosphate buffer.

25. A method according to claim 1, wherein said ionic solution comprises 150 mM sodium phosphate buffer, pH 8.5.

26. A method according to claim 1, wherein said printing quality is determined by evaluating the intensity of fluorescence of the printed samples.

27. A method according to claim 1, wherein said printing quality is determined by evaluating the morphology of fluorescence of the printed samples.

28. A method for determining the efficiency of a procedure to block non-specific binding on a nucleic acid array, said method comprising:
(a) printing an array of nucleic acid samples onto a solid support, each sample comprising nucleic acid in an ionic solution;
(b) subjecting said array to blocking procedures;
(c) detecting fluorescence of each printed sample before and after said blocking procedures, wherein a difference in detected fluorescence is indicative of the efficiency of the blocking procedures.

29. A method according to claim 28, wherein said fluorescence following said blocking procedures is undetectable.

30. A method according to claim 28, wherein s the intensity of fluorescence of the printed samples is evaluated.

31. A method according to claim 28, wherein the morphology of fluorescence of the printed samples is evaluated.
